(19) United States
(12) Patent Application Publication
(10) Pub. No.: US 2020/0211050 A1
(43) Pub. Date: Jul. 2, 2020

(54) SYSTEMS AND METHODS FOR REAL-TIME OPTIMIZATION OF ADVERTISEMENT PLACEMENTS ON A WEBPAGE

(71) Applicant: Mode Technologies, Inc., New York, NY (US)

(72) Inventor: MARK LEE, Harrisonburg, VA (US)

(21) Appl. No.: 16/728,713

(22) Filed: Dec. 27, 2019

Related U.S. Application Data
(60) Provisional application No. 62/786,153, filed on Dec. 28, 2018.
(60) Provisional application No. 62/786,163, filed on Dec. 28, 2018.

(51) Int. Cl. G06Q 30/02; G06N 20/00

(52) U.S. Cl. CPC G06Q 30/0244; G06Q 30/0273; G06N 20/00; G06Q 30/0201; G06Q 30/0277

(57) ABSTRACT

Embodiments disclosed herein provide for systems and methods of a real-time optimization of advertisement placements and advertisement types on a webpage. The system and methods provide for receiving signals on both the buy side (i.e., audience acquisition) and the sell side (i.e., the display of ads), and then transmitting the signals to the webpage to make decisions on what to show and what not to show. Further, machine learning may be utilized to understand exactly what the user is seeing and experiencing to make appropriate changes based on that specific user at that specific time.

### CROSS-REFERENCE TO RELATED APPLICATION

This application claims the benefit of the filing date of, and incorporates by reference thereto in its entirety, U.S. Provisional Patent Application Ser. Nos. 62/786,163 and 62/786,153, both filed on Dec. 28, 2018.

### TECHNICAL FIELD

The present application relates to a system and method for a real-time optimization of advertisement placements and advertisement types on a webpage.

### BACKGROUND

Online advertising is a multi-billion dollar industry. Online advertising has substantial benefits over traditional advertising such as television spots, billboards, magazines, etc. For example, with online advertising, advertisers are able to target their advertisements to users based on information (e.g., user's browser activity as well as any personal information entered by the user at a website) collected and stored by the user's web browser as the user browses a particular website (e.g., “cookies”). However, similar to traditional advertising, it has proven difficult in online advertising to determine an optimum placement for the advertisements. In particular, it is difficult to align the user experience on a webpage to the value of that user in order to deliver the optimal advertisement placement(s) and advertisement type(s), while also maintaining profitability. Currently, advertisement placement and advertising types are optimized based on the “average” value of all users. Further, the user's webpage experience is only changed based on Urchin Tracking Module (UTM) parameters.

Accordingly, there is a need for a real-time optimization of the advertisement placements and the advertisement types on the webpage.

### SUMMARY OF THE INVENTION

According to an embodiment, the invention relates to systems and methods for real-time optimization of advertisement placements on a webpage.

For example, according to an embodiment, a computer-implemented method for real-time optimization of advertisement placements on a webpage, the method comprising: receiving, with a rules engine, a cost associated with acquiring a user for the webpage; receiving, with the rules engine, a revenue associated with the acquired user on the webpage; collecting, with an intent engine, data associated with the webpage to identify an intent of the acquired user on the webpage; determining, with a machine vision engine, a current viewport of the webpage; and updating the advertisement placements on the webpage based on (i) the received cost and revenue, (ii) the collected data, and (iii) the determined current viewport.

Further, according to an embodiment, a system for real-time optimization of advertisement placements on a webpage, the system comprising: one or more processors, wherein the one or more processors are configured to: receive, with a rules engine, a cost associated with acquiring a user for the webpage; receive, with the rules engine, a revenue associated with the acquired user on the webpage; collect, with an intent engine, data associated with the webpage to identify an intent of the acquired user of the webpage; determine, with a machine vision engine, a current viewport of the webpage; and update the advertisement placements on the webpage based on (i) the received cost and revenue, (ii) the collected data, and (iii) the determined current viewport.

### BRIEF DESCRIPTION OF THE DRAWINGS

FIG. 1 illustrates an example of a stage engine according to an embodiment of the present invention.

FIG. 2 illustrates an example of the SuperTag engine according to an embodiment of the present invention.

FIG. 3A illustrates an example of a PageSocket system according to an embodiment of the present invention.

FIG. 3B illustrates the PageSocket system of FIG. 3A as the external service sends an event for action on the page.

FIG. 3C illustrates the PageSocket system of FIG. 3A as the page sends an event for action from the intern al API system.

FIG. 4 illustrates an example of a PageSocket system event according to an embodiment of the present invention.

FIG. 5 illustrates a flow diagram of an open real-time revenue engine according to an embodiment of the present invention.

FIG. 6A illustrates a real-time workflow example of a UTM cost/revenue summarizer according to an embodiment of the present invention.

FIG. 6B illustrates another real-time workflow example of a UTM cost/revenue summarizer according to an embodiment of the present invention.

FIG. 7 illustrates a system diagram according to an embodiment of the present invention.

### DESCRIPTION OF EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

One aspect of the present disclosure is to provide a system and method for a real-time optimization of the advertisement placements and the advertisement types on a webpage. The systems and methods herein address at least one of the problems discussed above.

According to an embodiment, signals on both the buy side (i.e., audience acquisition) and the sell side (i.e., the display of ads) are received by a system, and then transmitted to the webpage to make decisions on what to show and what not to show. Further, machine learning may be utilized to understand exactly what the user is seeing and experiencing to make appropriate changes based on that specific user at that specific time.

According to an embodiment, a method controls the webpage in real time and changes the experience based on signals from backend systems. The method may be implemented with a SuperTag engine (i.e. sell-side engine/client JavaScript page engine), where the ads are selected based on rules and injected into the page based on the signals sent to the client JavaScript. According to an embodiment, the SuperTag engine may be combined with the full feedback system to send signals to create, remove, or change the experience based on a comparison of the actual value of the user and the cost of acquisition. Further, the system can change the ad layouts or initiate various actions based on the profitability or value of the user, or the interaction taking place within the page (e.g., change/add/remove an advertisement if revenue is greater than or less than a certain value). According to an embodiment, with the SuperTag engine, content can be displayed without corresponding code in the webpage's code. Instead, logic associated with the SuperTag engine creates the content on the page. The SuperTag engine may also leverage a PageSocket system to allow for events to be transmitted both to and from the page and from any PageSocket-enabled connection. As such, with the SuperTag engine and the PageSocket system, content can be introduced into the webpage without the necessity of corresponding code in the webpage's code.

According to an embodiment, the PageSocket system creates a tunnel between the advertising optimization system and the webpage, and allows for communication to flow bi-directionally with commands being interpreted and broadcast to various levels of targeting. In particular, a command can be sent that targets a specific page view, audience member, session, or journey, thereby allowing commands from different domains that the user is on simultaneously to be sent, and to instruct and control the pages to perform specific actions triggered by a variety of different mechanisms.

According to an embodiment, an intent engine may utilize various page statistics to identify the intent of the user to identify the optimal time to display or place an ad. In particular, the intent engine utilizes data collected on the webpage to identify the intent of a user. This may be done using machine learning. This data may consist of mouse movements, finger movements, touch points, page scroll depth, page scroll speeds, content focus, and other data points, which may be fed into the intent engine to calculate an intent of the user based on the delta points in time.

According to an embodiment, another engine may utilize machine vision to understand the layout of the page, including what is content and what is open space. Accordingly, by analyzing the current viewport of the browser (e.g., what the browser is currently displaying), a new ad placement may he dynamically created in an area of the page without overlapping the content. According to an embodiment, the current viewport of the browser may be determined by ingesting the current webpage code including code associated with the size of the screen as well as code associated with the size of the different types of content, e.g., text, ads, images, etc. Further, the new ad placements may be determined using an optimal packing machine learning algorithm. In another embodiment, the new ad placements can be determined using recurrent neural networks.

Further, by combining the intent of the user (e.g., from the intent engine) with the machine vision, the system can better define placements to be created without overlapping of content in the correct moment that the user will be most likely to engage and interact with that placement for higher revenue. This is particularly valuable within the mobile space where injection of ad units between content should be initiated at the proper time to maximize both revenue and engagement.

According to an embodiment, the SuperTag engine may be combined with the full feedback system to send signals to create, remove, or change the experience based on a comparison of the actual value of the user and the cost of acquisition. Accordingly, the chosen advertisement placements may be manual (e.g., through SuperTag advertisement configuration) or machine-driven, thereby allowing the correct type, location, and unit to be chosen to maximize user experience and profitability. Further, by utilizing the PageSocket system, those choices can be computed in the backend and then submitted back to the specific webpage in real-time.

According to an embodiment, a content vision engine may use in-browser machine vision to identify, in real-time, what the user sees, and then create new placements based on advertisement density to ensure the content does not overlap. Further, it may use white space overlay as well as inline dynamic insertion between content targets. The content vision engine may also use machine vision to create maps of content as well as a “heat map” of content to identify the relationships for pleasing placements. According to an embodiment, the machine vision may understand structure to allow for scrolling stick, fixed positioning, and inline created as well as destruction of unfilled slots, overlapping content, or placement that is not as pleasing to the eye. Further, the content vision engine may also implement machine learning on mouse biometrics to identify the state of a user. Advertisements can be served more effectively to users if they are served at a point when they are willing to engage the advertisements.

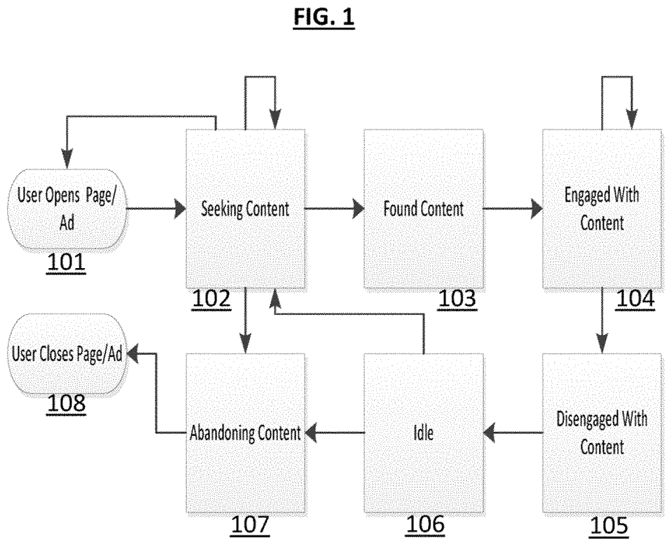

FIG. 1 illustrates an example of a stage engine according to an embodiment of the present invention. According to an embodiment, after a user opens a page/advertisement as depicted in step 101, they may go through a variety of different states of interaction, e.g., seeking content 102, found content 103, engaged with content 104, disengaged with content 105, idle 106, and abandoning content 107. After which, the user may then close the page/advertisement, as depicted in step 108.

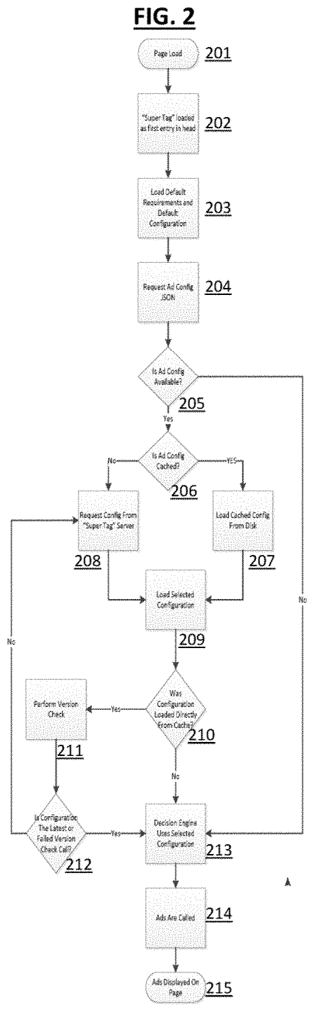

FIG. 2 illustrates an example of the SuperTag engine according to an embodiment of the present invention. As depicted in the figure, in step 201, a webpage is loaded. Then, in step 202, a “SuperTag” is loaded as a first entry in the head of the page. In particular, the SuperTag is fetched as a single line of JavaScript code. Then, in step 203, the default requirements and configurations for the advertisement placements are loaded by the engine, so that if the fetching of the configuration fails, it may use the default configuration to display an advertisement. Then, in step 204, an advertisement configuration is requested through a JSON interface. In particular, after getting its initial configuration, it will send a request for advertisement configuration from the SuperTag servers. In step 205, it is determined whether the advertisement configuration is available. If it is available, then the method proceeds to step 206. If not, then the method proceeds to step 213. If the ad configuration servers are unavailable, it will use the default configuration after trying AJAX and PageSocket calls to retrieve the configuration. At step 206, it is determined whether the advertisement configuration is a locally-cached version of the configuration. If it is, then the cached configuration is loaded from the disk as depicted in step 207. Otherwise, the method proceeds to step 208, where the configuration is requested from a “SuperTag” server. According to an embodiment, the method proceeds to step 209 after either step 207 or step 208. At step 209, the selected configuration is loaded. Then, in step 210, it is determined whether the configuration was loaded directly from the cache. If it is, then the method proceeds to step 211, where a version check may be performed. Further, a cache bust may also be preformed by appending a GET Variable string to ensure that the latest version is retrieved. Further, if the latest version is retrieved, and it is a later version than what is currently being held, the new non-cache version will be used. If not, then the method proceeds to step 213. According to an embodiment, after the version check, it is determined whether the configuration is the latest or failed version check call. If it is, then the method proceeds to step 213. Otherwise, the method proceeds to step 208. At step 213, the decision engine uses the selected configuration. Then, in step 214, the advertisements are called. Lastly, in step 215, the advertisements are displayed on the webpage.

Further, according to an embodiment, upon receiving its configuration, the SuperTag engine can then execute the commands held within the configuration to target and create various ads, html elements, or scripts via the configuration sent. Further, PageSocket may also be loaded, and commands for real-time control are also available for instructed changes and events via the PageSocket pipeline as well as the content vision and intent engine. In particular, the configuration allows for specific page elements to be targeted as well as actions to be performed based on the triggers within the configuration or commands executed through PageSocket or any other service modules enabled.

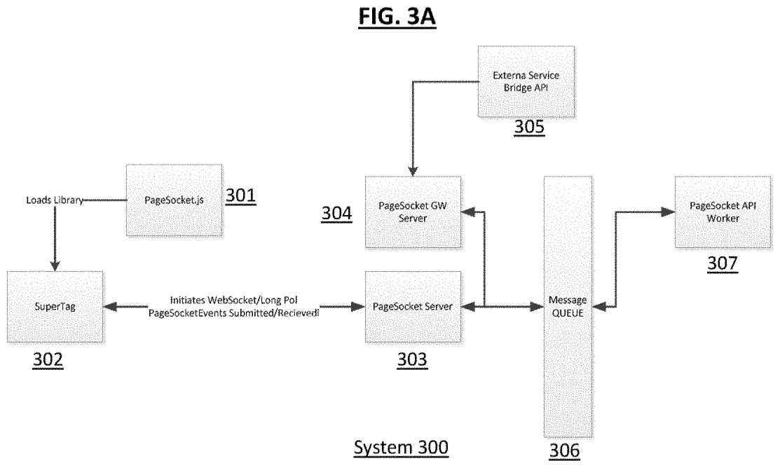

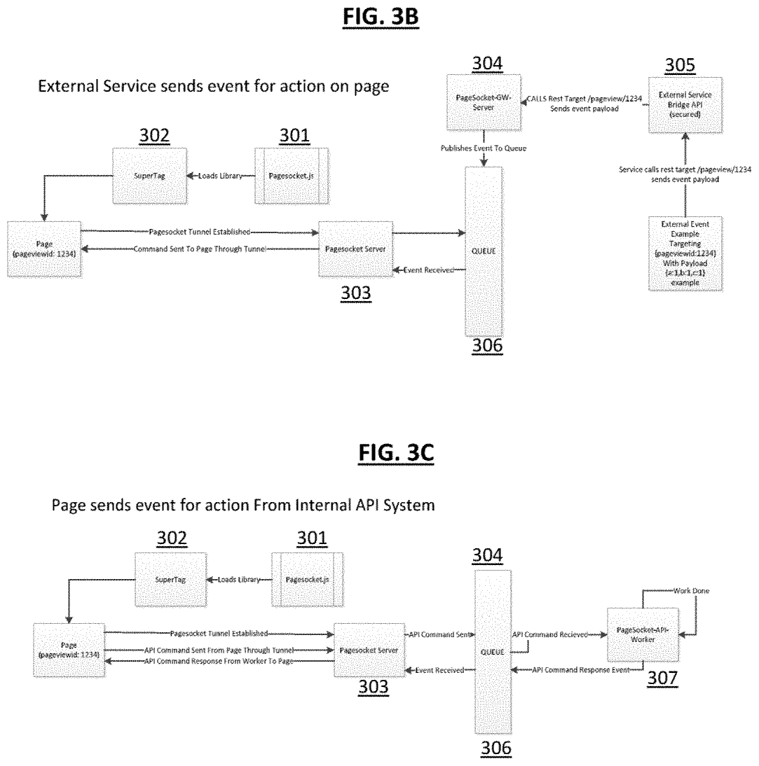

FIG. 3A illustrates an example of a PageSocket system according to an embodiment of the present invention. As depicted in the figure, a PageSocket system 300 includes a PageSocket.js client 301, a SuperTag engine 302, a PageSocket socket server 303, a PageSocket gateway server 304, an external service bridge application program interface (API) 305, a message queue 306, and a PageSocket API worker 307. According to an embodiment, PageSocket is a WebSocket/long poll service that allows for events fired from backend systems to be submitted and received from the webpage. It consists of a frontend JavaScript library and a number of backend services with a defined API that allows for events to flow back and forth from the page, thereby allowing for cross domain communication. According to an embodiment, the PageSocket gateway server 304 is the endpoint to which the PageSocket.js client 301 connects. The PageSocket gateway server 304 allows for events to be sent and received between the two. Further, a PageSocket API is a restful layer for communication between the gateway 304 and the webpage to emit and receive events. According to an embodiment, the PageSocket API is located between 301/302 and 303 and allows for submission and processing of events on either side through the tunnel. SuperTag 302 uses PageSocket.js 301 to send events over the tunnel (e.g. a browser WebSocket) to PageSocket server 303. Those events are sent as PageSocket commands and are then processed and submitted to the message queue 306. The API worker 307 processes those events and performs corresponding actions, e.g., sending internal or external calls to systems. If a command is sent back to the page, the external service bridge API 305 is called with the rest target e.g., a page view, audience, session, etc. The bridge 305 calls the PageSocket GW service 304 to publish the command back to the queue 306, where it is picked up by the PageSocket server 303 and sent to the client 302 through the connection within PageSocket.js 301 for action on the page(s) of the target. Further, the PageSocket API worker 307 will receive events from the queues that are pushed for the PageSocket ARI. Further, the PageSocket API workers 307 listen to the queue 306 for commands to perform actions, e.g., triggering internal processes or other APIs to dispatch work or calculation. The workers 307 attach to the queue to allow for command execution to be done and, if required, communication to be sent back to the targets via the PageSocket server 303 from the queue dispatch. Further, FIG. 3B illustrates the system 300 as the external service sends an event for action on the page, and FIG. 3C illustrates the system as the page sends an event for action from the internal API system.

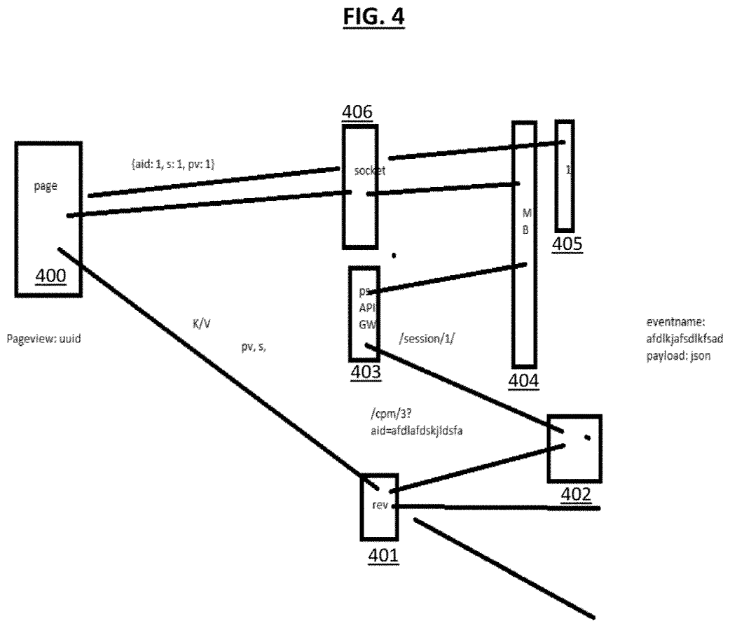

FIG. 4 illustrates an example of a PageSocket system event according to an embodiment of the present invention. In particular, the figure shows an example of the revenue pixel 401 being called. The revenue pixel 401 corresponds to an image web service that generates and returns an image file, e.g., a .GIF file, when it is called. In particular, the revenue pixel 401 corresponds to an image web service for executing a sell-side alert of the monetization of an item, e.g., a display, page, view, action, conversion, or item sell. According to an embodiment, the page view universal unique identifier (e.g., Page view: uuid) and audience information is sent to the revenue pixel for $3 CPM (i.e., cost per thousand impressions), which is then processed and triggers a call to the service bridge 402. The bridge 402 then triggers a call to the PageSocket gateway (GW) 403 targeting session/1 in this example. The PageSocket GW 403 then publishes to the queue 404. The PageSocket server 406 then sees the call for session 1 for the revenue event and sends it through the tunnel 405 via the PageSocket server 406 to the page 400 for action to be taken.

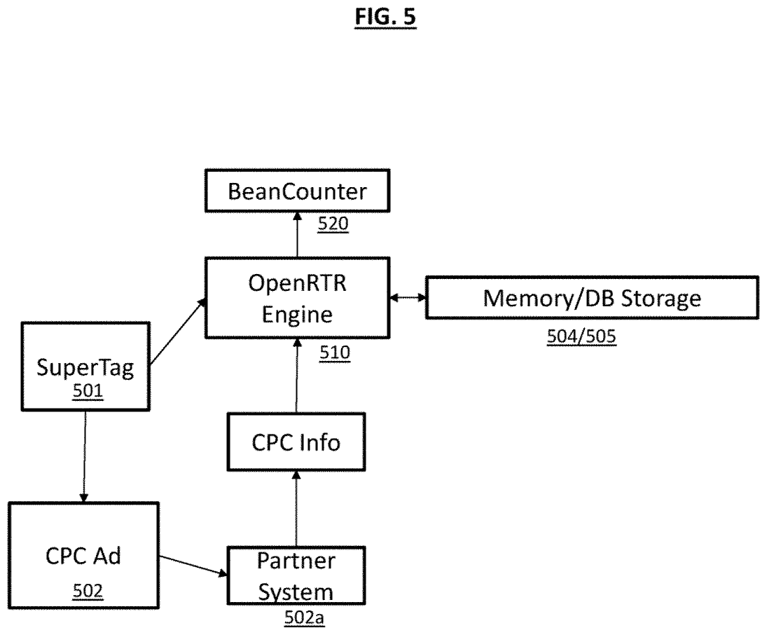

FIG. 5 illustrates a flow diagram of an open real-time revenue engine according to an embodiment of the present invention. With an open real-time revenue (OpenRTR) engine, if a revenue event happens asynchronously, e.g., sometime after the fact, it can still be associated with the initial user interaction with the advertisement. OperRTR is a specification for an open interchange standard of revenue information. With OpenRTR, various sell/buy partners can be related to each other via correlation IDs and combined to allow for a push/pull architecture to sync costs and revenues across distributed systems. This is accomplished by implementing a correlation ID of transactions across partners that can be submitted back and forth across systems to glue together different parameters and matchups for a unified view of what happens from a buy/sell perspective. For example, an OpenRTR correlation ID of 12344567 can internally map to audience: 1234, session: 1234, journey: 1234, page view: 1234, which can be sent over to a sell-side partner when called. In response, the partner fires back at the OpenRTR endpoint correlation ID: 12344567 and the event that took place, i.e., sell: cpm 5, which can trigger logging and internal events into the system from. On the buy side, another partner executes a correlation ID on the page landing that is then passed and mapped to internal values, thereby closing the loop from the buy side. As such, if an action that generates revenue occurs after the user has left the webpage, the initial event that took place and the time period that it happened can still be generated using the correlation ID. For example, as depicted in the figure, a SuperTag, engine 501 generates a correlation ID for a particular advertisement 502 and submits the correlation ID to an OpenRTR engine 510 for later attribution. The OpenRTR engine 510 then stores the correlation ID with a universal unique identifier (UUID) in either the memory cache (or memcached) 504 or a database 505 (e.g., for longer term storage than the memory cache 504). Then, assuming the advertisement 502 is clicked at a later time, the advertisement 502 sends the corresponding correlation ID and revenue information, e.g., via click transfer, to the third-party partner system 502a which is associated with the advertisement 502. In this regard, the partner system 502a can be the advertiser behind the advertisement 502. The partner system can then provide the correlation ID, the revenue information (e.g., cost per click (CPC)), along with other partner-specific information to the OpenRTR engine 510. The OpenRTR engine 510 can then retrieve previously-stored information using the correlation ID and transmits the previously-stored information and the partner-provided information to the Bean Counter 520 (e.g., impression revenue service), which keeps track of the recorded record of the revenue. As such, if the user is acquired again, the system can generate an appropriate user experience reflective of the user's increased value to the eve page's owner, e.g., by generating fewer advertisements 502 on the webpage.

According to embodiment, the OpenRTR engine 510 may include an OpenRTR application program interface (API) service, a revenue (sell) pixel, a cost (buy) pixel, a correlation service, a UTM cost/revenue service, and a UTM cost/revenue summarizer service. The OpenRTR API service is a representational state (RESTful) API service that implements the OpenRTR specification for http(s) endpoints. The revenue pixel corresponds to an image web service for executing a sell-side alert: of the monetization of an item, e.g., a display, page view, action, conversion, or item sell. The revenue pixel may be modified to allow for page views (e.g., via page view ID) and impressions (e.g., via impression ID) to be executed for loopback into the PageSocket system. Further, according to an embodiment, the buy pixel corresponds to an image web service for executing a buy-side alert of the monetization of an item, e.g., a display, page view, action, conversion, or item buy. The correlation service aligns different UUIDS from partners. The UTM cost/revenue service aligns the cost/revenue to UTM tracking codes along with audience, session, journey, page, and impression information. The UTM cost/revenue summarizer service tracks summarized data by UTM parameters, journeys, sessions, and audience members. Further, the UTM cost/revenue summarizer service will return CPM, total revenue/cost, total impressions, audience sessions, journeys, page views per combination, etc. Further, the summarizer also stores summarized information inside a summary table for permanent storage, which can take place in the background from summarization workers. According to an embodiment, the UTM cost/revenue summarizer service is utilized with the help of a unified time management system, i.e., timeslice. Timeslice creates “slices” of time as well as a unified ID that is used to combine multiple summarization services together to an exact period of time, because the summarization varies greatly based on the duration of time measured. For example, a timeframe may consist of the following values:

time period 1: [a, b]=2 unique units,

time period 2: [b, c]=2 unique units,

time period 3: [d, b, e]=3 unique units, and

time period 4: [d, b, e, f]=4 unique units.

According to an embodiment, if the values of tinge period 1 and time period 2 were taken together as a duration (timeslice), the unique count would be 3. However, if the two time periods were added together, the unique count would be 4, which is incorrect. Further, if all 4 periods were added together, there would be 11 unique units. However, if all of the time periods were taken together into a timeslice of duration of period 1-4, the unique count would be 6. The timeslice service allows for the unification of the various durations of time to align various summarizations together into discrete periods of time to get the closest, most accurate result (if a timeslice is available of the specific duration), or to get the largest periods of summarization available to get the closest approximation across many different services and summarizations.

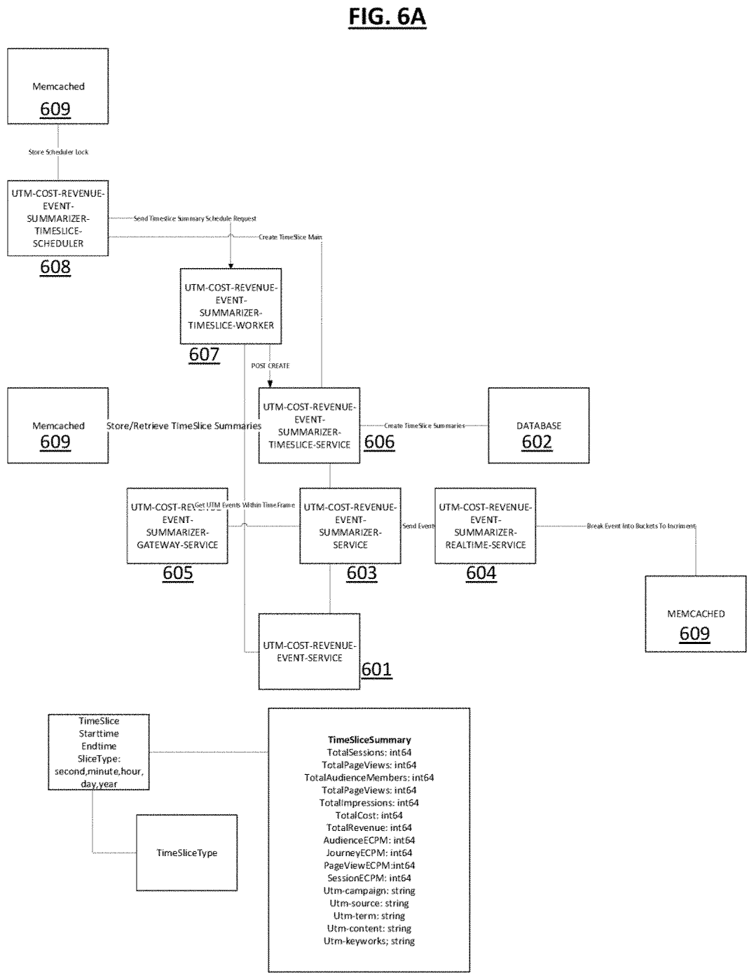

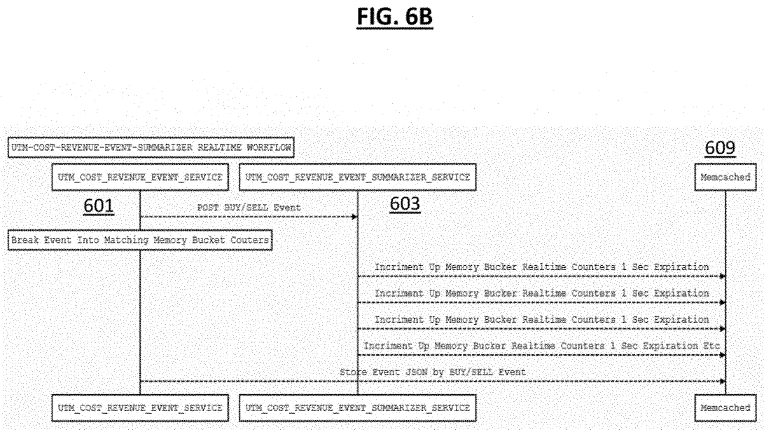

Methods for providing real time and summarized data are shown in FIGS. 6A and 6B. A buy event may be triggered from a link click through link redirector or redirection service/system (Linkr), this would emit a “buy” event from Linkr to a UTM cost/revenue event service, which would then store the corresponding audience ID, session ID, journey ID, page view ID, cost, and UTM tracking information. When sell events take place through the revenue pixel, those would in turn call the UTM cost/revenue event service 601 which would log the sell event with the same information. Further, as depicted in FIG. 6A, the UTM cost/revenue event service 601 can store this information and hash together the different values for fast lookup for future summarization and normalization. This information can then get written to the database 602 from the UTM cost/revenue event service 601. Further, each of these events are sent over to the UTM cost/revenue event summarizer service 603, which in turn sends the events to the UTM cost/revenue event summarizer real-time service 604. The real-time service 604 separates the received events into various “buckets” based on the hashes available e.g., UTM campaign, session, audience, etc. Each bucket has a buy/sell target that gets incremented with the received values and has short time memory storage to provide real-time summaries for requests where a timeslice summary has not yet been generated. Further, according to an embodiment, requests for getting a summary are handled via the UTM cost/revenue event summarizer gateway service 605, which directs either a request for getting the information from the real-time or timeslice summarization services based on the period of time selected.

Further, the UTM cost/revenue summarizer timeslice service 606 creates and retrieves the summarizations from the UTM cost/revenue event summarization timeslice worker 607, which retrieves timeslice schedule calls from UTM cost/revenue event summarizer timeslice-scheduler 608 and distributes the work out to the timeslice workers at specified intervals.

FIG. 6B illustrates a request for the real-time workflow. When running a highly-distributed and high transaction system, understanding what is happening in the moment is difficult. Due to the I/O bound limitations of querying the database for certain data, real-time memory counters are stored so that the system can be accurate to what is happening at the specific periods of time prior to the “write” taking place at the long term data storage layer. Further, the event components are separated into various buckets of counters for the different components with short time expirations to provide the real-time diagnostics of what is taking place without having to wait for the I/O to occur at the database layer. This provides for real-time metrics as well as the handling of large volumes of transactions.

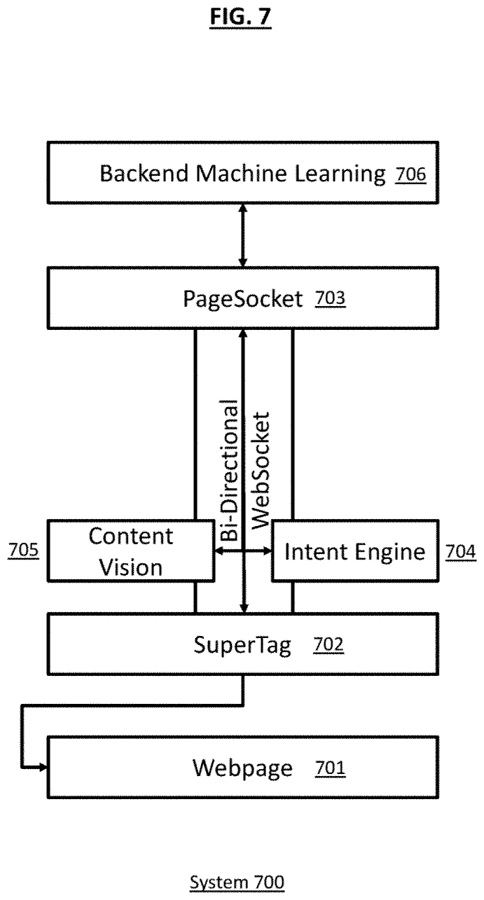

FIG. 7 illustrates a system diagram according to an embodiment of the present invention. As depicted in the figure, a system 700 includes a webpage 701, a SuperTag engine 702, a PageSocket system 703 (including a bi-directional WebSocket), an intent engine 704, a content vision engine 705, and backend machine learning 706.

According to an embodiment the SuperTag engine 702 corresponds to a rules engine that tracks a number of activities in the webpage, e.g., revenue from an advertisement. In particular, the SuperTag engine 702 can be a sell-side engine/client JavaScript page engine, where the advertisements can be generated and are selected based on rules, and injected into the webpage based on the signals sent to the client JavaScript. Further, the SuperTag engine 702 can be implemented in the webpage via a short strand of specific code, e.g., JavaScript code, embedded in the webpage's code. According to an embodiment, with the SuperTag 702, the advertisements can be displayed without corresponding code in the webpage's code. Instead, logic associated with the SuperTag engine 702 can generate the advertisement(s). Further, the SuperTag engine 702 can fire additional actions and triggers based on the value of the received revenue associated with a user.

According to an embodiment, the PageSocket system 703 creates a tunnel (e.g., using a bi-directional WebSocket) between the advertising optimization system and the webpage, and allows for communication to flow bi-directionally with commands being interpreted and broadcast to various levels of targeting. In particular, a command can be sent that targets a specific page view, audience member, session, or journey, thereby allowing commands from different domains that the user is on simultaneously to be sent, and to instruct and control the pages to perform specific actions triggered by a variety of different mechanisms. Further, according to an embodiment, the SuperTag engine 702 may also leverage the PageSocket system 703 to allow for events to be transmitted both to and from the page and from any PageSocket-enabled connection. As such, with the SuperTag engine 702 and the PageSocket system 703, content can be introduced into the webpage without the necessity of corresponding code in the webpage's code.

According to an embodiment, the intent engine 704 can utilize various page statistics to identify the intent of the user to identify the optimal time to display or place an ad. In particular, the intent engine 704 utilizes data collected on the webpage to identify the intent of a user. This may be done using machine learning 706. This data may consist of mouse movements, finger movements, touch points, page scroll depth, page scroll speeds, content focus, and other data points, which may be fed into the intent engine 704 to calculate an intent of the user based on the delta points in time.

According to an embodiment, the content vision engine 705 can utilize the in-browser machine vision to identify, in real-time, what the user sees, and then create new placements based on advertisement density to ensure the content does not overlap. Further, it may use white space overlay as well as inline dynamic insertion between content targets. The content vision engine 705 may also use machine vision to create maps of content as well as a “heat map” of content to identify the relationships for pleasing placements. According to an embodiment, the machine vision may understand structure to allow for scrolling stick, fixed positioning, and inline created as well as destruction of unfilled slots, overlapping content, or placement that is not as pleasing to the eye. Further, the content vision engine 705 may also implement machine learning 706 on mouse biometrics to identify the state of a user.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the foregoing Description of Embodiments, various features may be grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Description of Embodiments, with each claim standing on its own as a separate embodiment of the invention.

Moreover, it will be apparent to those skilled in the art from consideration of the specification and practice of the present disclosure that various modifications and variations can be made to the disclosed systems without departing from the scope of the disclosure, as claimed. Thus, it is intended that the specification and examples be considered as exemplary only, with a true scope of the present disclosure being indicated by the following claims and their equivalents.

1. A computer-implemented method for real-time optimization of advertisement placements on a webpage, the method comprising:
receiving, with a rules engine, a cost associated with acquiring a user for the webpage;
receiving, with the rules engine, a revenue associated with the acquired user on the webpage;
collecting, with an intent engine, data associated with the webpage to identify an intent of the acquired user on the webpage;
determining, with a machine vision engine, a current viewport of the webpage; and
updating the advertisement placements on the webpage based on (i) the received cost and revenue, (ii) the collected data, and (iii) the determined current viewport.

2. The method of claim 1, wherein the rules engine is implemented as particular code in the webpage's code.

3. The method of claim 2, wherein the particular code is JavaScript code.

4. The method of claim 1, wherein the collected data is at least one of mouse movements, finger movements, touch points, page scroll depth, page scroll speeds, and content focus.

5. The method of claim 1, wherein the current viewport is determined by ingesting the webpage's code and identifying code associated with sizes of the current viewport and the advertisement placements within the current viewport.

6. The method of claim 1, further comprising:
dynamically generating a new advertisement placement in an area of the webpage without overlapping content.

7. The method of claim 6, wherein the new advertisement placement is generated using an optimal packing machine learning algorithm.

8. The method of claim 6, wherein the new advertisement placement is provided to the webpage with the rules engine.

9. A system the real-time optimization of advertisement placements on a webpage, the system comprising:
one or more processors, wherein the one or more processors are configured to:
receive, with a rules engine, a cost associated with acquiring a user for the webpage;
receive, with the rules engine, a revenue associated with the acquired user on the webpage;
collect, with an intent engine, data associated with the webpage to identify an intent of the acquired user of the webpage;
determine, with a machine vision engine, a current viewport of the webpage; and
update the advertisement placements on the webpage based on (i) the received cost and revenue, (ii) the collected data, and (iii) the determined current viewport.

10. The system of claim 9, wherein the rules engine is implemented as particular code in the webpage's code.

11. The system of claim 10, wherein the particular code is JavaScript code.

12. The system of claim 9, wherein the collected data is at least one of mouse movements, finger movements, touch points, page scroll depth, page scroll speeds, and content focus.

13. The system of claim 9, wherein the current viewport is determined by ingesting the webpage's code and identifying code associated with sizes of the current viewport and the advertisement placements within the current viewport.

14. The system of claim 9, wherein the one or more processors arc configured to:
dynamically generate a new advertisement placement in an area of the webpage without overlapping content.

15. The system of claim 14, wherein the new advertisement placement is generated using an optimal packing machine learning algorithm.

16. The system of claim 14, wherein the new advertisement placement is provided to the webpage with the rules engine.
